(19) United States
(12) Patent Application Publication
(10) Pub. No.: US 2011/0199802 A1
(43) Pub. Date: Aug. 18, 2011

(54) SINGLE ENDED POWER CONVERTERS OPERATING OVER 50% DUTY CYCLE

(75) Inventor: Ching-Shan Leu, Taoyuan County (TW)

(73) Assignee: National Taiwan University of Science and Technology, Taipei (TW)

(21) Appl. No.: 13/092,995

(22) Filed: Apr. 25, 2011

Related U.S. Application Data
(63) Continuation-in-part of application No. 12/102,877, filed on Apr. 15, 2008.

(51) Int. Cl. H02M 7/537

(52) U.S. Cl. 363/131

(57) ABSTRACT

This invention discloses apparatus and methods for increasing the duty cycle of the single ended power converters surpass 50 percent limitation by adding active switch-capacitor network to the primary circuit and several inversion circuits can be realized to convert a DC input to an AC output. The circuits comprise two series circuits, at least one clamp clamping capacitor, and at least one transformer. The first series circuit includes one active switch paralleled with a diode, one capacitor and at least one transformer primary. The second series circuit includes at least one active switch and at least one transformer primary. At least one clamp clamping capacitor couples the first and the second series circuits, and is attached to each series circuit at a node between the respective transformer primary winding.

### CROSS-REFERENCE TO RELATED APPLICATION

This is a continuation-in-part application of and claims the priority benefit of U.S. patent application Ser. No. 12/102,877, filed Apr. 15, 2008, now pending. The entirety of the above-mentioned patent application is hereby incorporated by reference herein and made a part of this specification.

### BACKGROUND OF THE INVENTION

1. Field of Invention

The present invention is related to the field of power converter, and more specifically, to single ended power converters operate beyond the 50% duty cycle limitation.

2. Description of Related Art

Achieving a higher power density is an endless goal of modern power converter engineers for the crucial applications wherein the allocated space of the power converter is limited. In addition to being highly compact, the power converter has to be able to minimize the power dissipation.

In low-to-medium level power conversion applications, single-ended power converter topology, such as a forward converter or a flyback converter, is widely used. It includes an isolation transformer, at least one active switch on the primary side of the transformer, a rectifier and an output filter on the secondary side of the transformer. By way of the on/off control of the power active switch, an AC voltage is generated in the transformer primary from input DC voltage and converted to another value in the transformer secondary. After being rectified and filtered, DC output power with different voltage/current combinations can be obtained.

An issue of concern regarding aforementioned converters is that a magnetizing and the leakage energies stored in the transformer must be taken into consideration during the design of the converter. Otherwise, these magnetic energies stored in the transformer may cause the failure of the converter.

Another issue of concern regarding aforementioned converters is to alleviate the electromagnetic interference EMI problems. Part of the EMI problems is caused by the pulsating current ripples, di/dt, in the power converters. Also, the lower the pulsating current ripples, the lower the RMS value of the current. As a result, conduction losses can be reduced to improve the efficiency. Therefore, a power converter with a low input current ripple becomes one of the design criteria of concern.

To achieve a low current ripple as well as to recycle the transformer's magnetizing and leakage energies, several single ended power converters have been proposed in the literatures and become the prior art of the present invention.

One of which shown in FIG. 1 is the single ended power converter proposed for low power level applications in “Design Tricks, Techniques and Tribulation at High Conversion Frequencies,” Bruce Carsten, HFPC 1987, pp. 139-152 and is also plotted in “Snubber Circuits: Theory, Design and Application,” Philip C. Todd, TI seminar 900. Topic 2, 1993. However, no detailed descriptions are offered in both papers. Recently, its input current ripple reduction property has been explored by the inventor of the present invention in “Improved Forward Topologies for DC-DC Applications with Built-in Input Filter,” Ph.D. dissertation, Virginia Polytechnic & State University, Blacksburg, Va., U.S.A., 2006.

This circuit contains a single active switch which is selected to withstand higher than the input voltage. In some applications, ample voltage-rating MOSFETs as the active switches may be available at the cost of increasing the conduction losses due to the higher voltage-rating MOSFET accompanied with a higher R_{DSon}. On the contrary, voltage stress may be too high for available active switches in many other applications.

By series-connecting two active switches, the voltage stress on each device can be reduced. Using low-voltage rating MOSFET as an example, the equivalent R_{DS(ON)} is reduced. As a result, the conduction losses can be significantly reduced and improve the converter's efficiency. As shown in FIG. 2, it was invented in U.S. Pat. No. 7,515,439, issued on Apr. 7, 2009, to the inventor of the present invention. Each of the two series-connected active switches has been designed to accommodate rated for approximately the input voltage.

To further reduce the input/output current ripple by means of the ripple cancellation mechanism, another one of which is shown in FIG. 3. It was invented in U.S. Pat. No. 5,523,936, issued on Jun. 4, 1996, to the inventor of the present invention.

Again, to take the advantage of reducing the voltage stress, the circuit diagram of its two active switch version is shown in FIG. 4. It was invented in U.S. Pat. No. 7,515,439, issued on Apr. 7, 2009, to the inventor of the present invention.

Because the transformer reset voltage of the aforementioned single ended power converters is equal to the input voltage, a maximum duty cycle is limited to 50%. The turns ratio of the transformer is thus restricted to a smaller value resulting in accompanying with a higher RMS input current and higher rectifier's voltage stress. Consequently, the conduction losses are increased.

Accordingly, those skilled in the art understand that one of the effects of increasing the duty cycle of the power active switch is that an overall efficiency of the single ended power converter can be increased.

A system and method is thus needed to maximize the converter's efficiency by means of recovering the magnetic energies, decreasing the current ripple, reducing voltage stress, and allowing above 50% duty cycle operation.

### SUMMARY OF THE INVENTION

Accordingly, an object of the present invention is to provide inversion circuits having reduced input current ripple thereby to alleviate the EMI problems and to improve the converter's efficiency.

A further object of the present invention is to provide inversion circuits employing clamping capacitor to recycle the magnetic energies thereby to improve the converter's efficiency.

A further object of the present invention is to provide inversion circuits using low voltage-rating active switch thereby to improve the converter's efficiency.

A further object of the present invention is to provide inversion circuits surpassing 50% duty cycle thereby to improve the converter's efficiency.

In order to make the aforementioned and other objects, features and advantages of the present invention comprehensible, several preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1, FIG. 2, FIG. 3, and FIG. 4 are the circuit diagrams of the single ended power converter as prior art of the present invention.

FIG. 5A FIG. 5B and FIG. 5C illustrate three embodiments of the single ended power converter accordance with the present invention.

FIG. 6A and FIG. 6B illustrate another two embodiments of the single ended power converter accordance with the present invention.

FIG. 7A, FIG. 7B and FIG. 7C illustrate another three embodiments of the single ended power converter accordance with the present invention.

FIG. 8A, FIG. 8B and FIG. 8C illustrate another three embodiments of the single ended power converter accordance with the present invention.

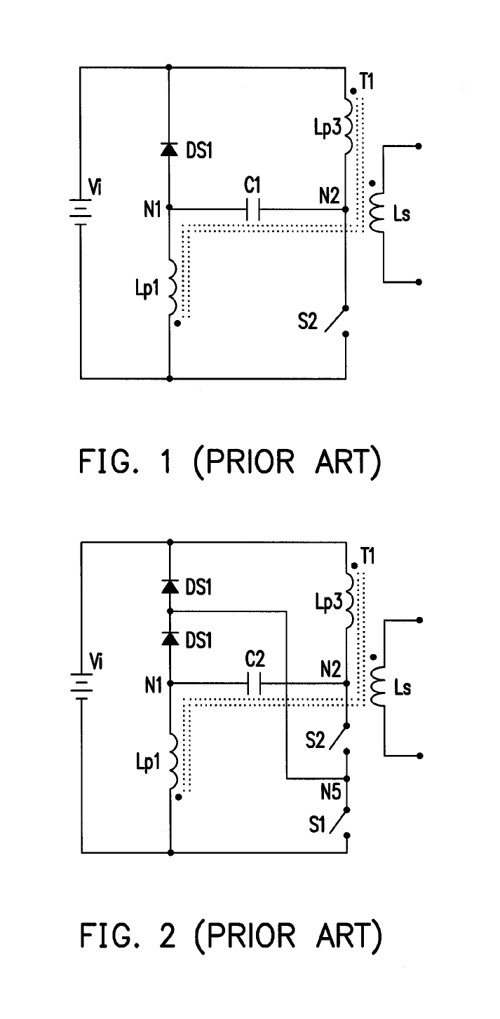

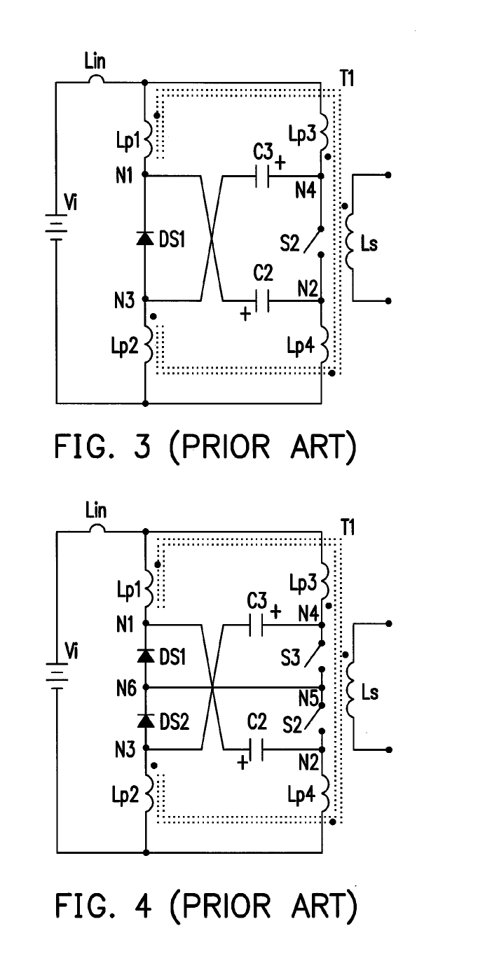

### DESCRIPTION OF EMBODIMENTS

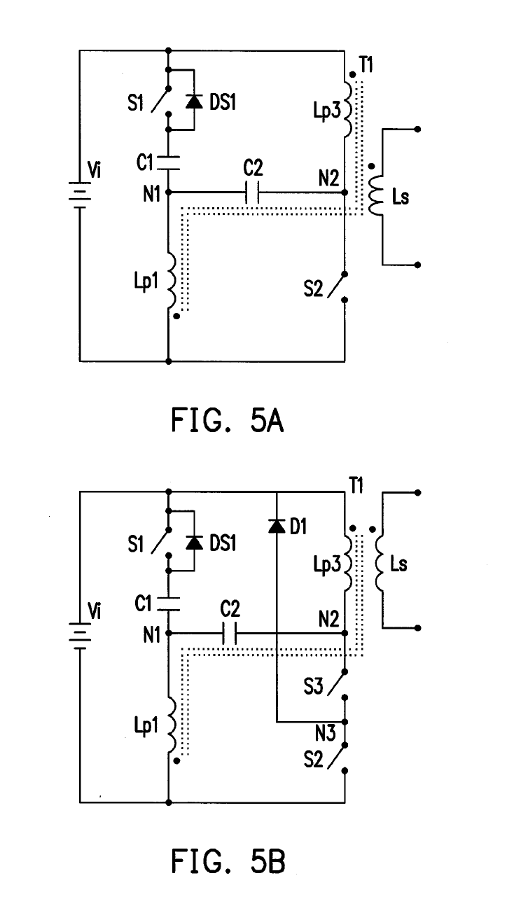

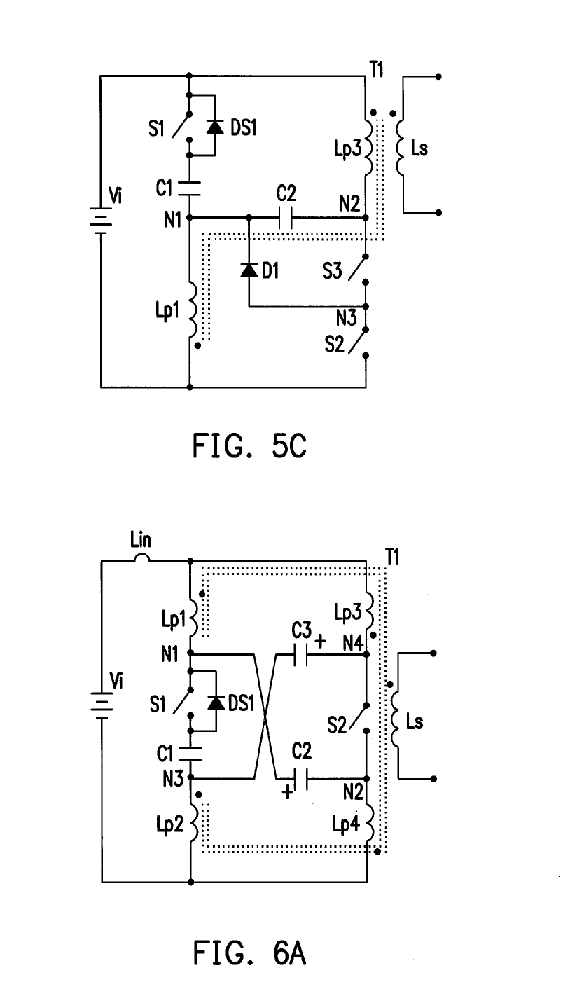

As illustrated in FIG. 5A is a circuit diagram of the single ended power converter to introduce the concept of resetting a transformer via the clamping capacitors of the present invention. The circuit used to convert a DC input to an AC output comprises two series circuits, one clamping capacitor C2, and one transformer T1. The transformer T1 has two identical primary windings Lp1 and Lp3 and at least one secondary winding Ls. Both series circuits are connected in parallel with the DC input source Vi. The first series circuit comprises a first active switch S1 paralleled with a first diode DS1, a first clamping capacitor C1, and the first transformer primary winding Lp1; while the second series circuit comprises the second transformer primary winding Lp3, a second active switch S2. Wherein the first diode DS1 is the body diode of the first active switch S1 or an external diode. The second clamping capacitor C2 is used to couple the first series circuit and the second series circuit by connecting a first node N1 and a second node N2, wherein the first node N1 is a node between the first clamping capacitor C1 and the first transformer primary Lp1 in the first series circuit, and the second node N2 is a node between the second transformer primary Lp3 and the second active switch S2. A driver signal is issued by the control circuit (not shown) to turn on/off the active switch S2 of the second series circuit. On the other hand, a complementary driver signal is also issued by the same control circuit to turn on/off the active switch S1 of the first series circuit. Consequently, an AC voltage is thus generated in the transformer secondary winding Ls. After being rectified and filtered (not shown), the output of the power converter provides an output voltage V0 to a load.

The single ended power converter operates as follows. Before the first time interval, both active switches S2 and S1 are turned off. During a first time interval, one gate drive signal is issued to turn on the active switch S2. In addition to the input voltage Vi applied to the second primary winding Lp3, the clamping capacitor voltage V_{C2} is also applied to the first primary winding Lp1. A magnetizing current associated with the transformer T1 increases linearly. At the end of the first time interval, the gate drive signal turns off the active switch S2. The energy stored in the leakage inductance of the transformer T1 is absorbed by the second clamping capacitor C2 and the first clamping capacitor C1. Therefore, the voltage across the active switch S2 has no voltage spike and is limited to the sum of the three voltages provided by the voltage across the second clamping capacitor C2, the voltage across the first clamping capacitor C1, and the input voltage Vi.

Due to the forward biased, DS1 is turned on. The transformer reset voltage is thus equal to the sum of the voltages across the clamping capacitors, C1 and C2. This operation condition is still valid because a complementary gate driver signal is applied to turn on the active switch S1 before DS1 is turned off. Since the voltage across the clamping capacitor C2 is clamped to input voltage Vi, the reset voltage can be thus higher than the input voltage. The duty cycle of the active switch, therefore, can be above 50%.

Obviously, a higher than 50% operating duty cycle results in increasing transformer turns ratio accompanied with a low primary current and lower voltage stresses on the secondary rectifiers. Consequently, further improvements of the single ended power converter's efficiency can be achieved.

Turning now to FIG. 5B is another embodiment of the single ended power converter constructed according to the foregoing principles of the present invention. Two series-connected active switches S2 and S3 are used to replace the active switch S2 in FIG. 5A. Moreover, a clamping diode D1 is connected between the DC input and center node of the second active switch and the third active switch to clamp the voltage across active switches S2 and S3. The active switches, S2 and S3, are turned on simultaneously. To assure the voltage-clamping function performed by the clamping diode D1, however, the turn-off timing of the gate drivers between the switches has to be designed properly. The active switch S3 should not be turned off before the active switch S2 in the circuit FIG. 5B. The voltages across the active switch S2 and S3 are thus clamped to Vi, and Vi+V_{C1}, respectively. As a result, lower voltage rating active switch can be used for S2 and S3 and decrease the conduction loss.

FIG. 5C is another embodiment of the single ended power converter constructed according to the foregoing principles of the present invention. Two series-connected active switches S2 and S3 are used to replace the active switch S2 in FIG. 5A. Moreover, a clamping diode D1 is connected between the said first node N1 and center node of the second active switch and the third active switch to clamp the voltage across active switches S2 and S3. The active switches, S2 and S3, are turned on simultaneously. To assure the voltage-clamping function performed by the clamping diode D1, however, the turn-off timing of the gate drivers between the switches has to be designed properly. The active switch S3 should be turned off before the active switch S2 in the circuit FIG. 5C. The voltages across the active switch S2 and S3 are thus clamped to Vi+V_{C1}, and Vi, respectively. As a result, lower voltage rating active switch can be used for S2 and S3 and decrease the conduction loss.

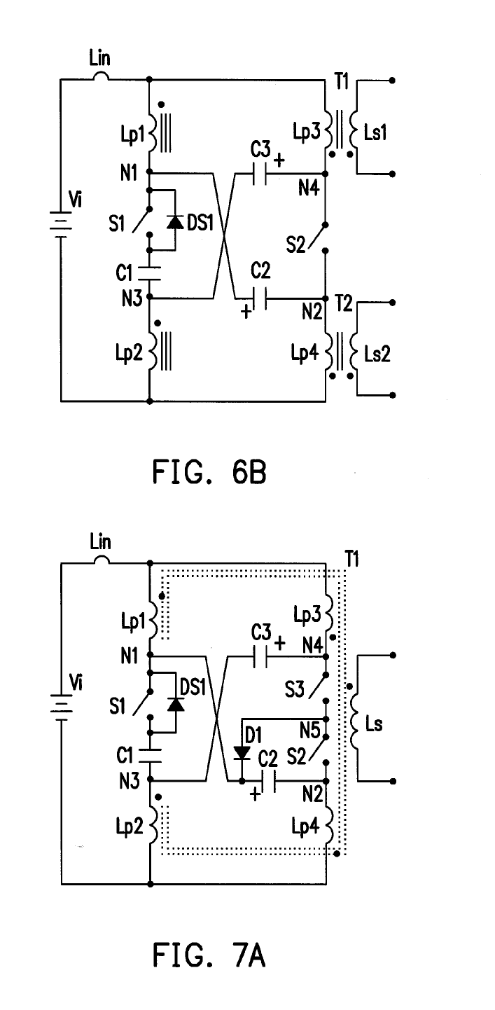

As illustrated in FIG. 6A is another circuit diagram of the single ended power converter to introduce the concept of resetting a transformer via the clamping capacitors as well as to further reduce the current ripple of the present invention. The circuit used to convert a DC input to an AC output comprises two series circuits, two clamping capacitors (C2 and C3), and one transformer T1. The input inductor, Lᵢₙ represented the parasitic inductor or an external inductor is inserted between the DC input Vi and the two series circuits. The transformer T1 has four identical primary windings Lp1, Lp2, Lp3 and Lp4 and has at least one secondary winding Ls. The first series circuit comprises the first transformer primary Lp1, a first active switch S1 paralleled with a first diode DS1, a first clamping capacitor C1, and a second transformer primary Lp2; while the second series circuit comprises a third transformer primary Lp3, a second active switch S2, and the fourth transformer primary Lp4. Wherein the diode DS1 is the body diode of the first active switch S1 or an external diode. The second clamping capacitor C2 is used to couple the first and the second series circuits by connecting a first node N1 and a second node N2, wherein the first node N1 is a node between the first transformer primary Lp1 and the first active switch S1, and the second node N2 is a node between the active switch S2 and the fourth transformer primary Lp4. The third clamping capacitor C3 is used to couple the first and the second series circuits by connecting a third node N3 and a fourth node N4, wherein the third node N3 is a node between the first clamping capacitor C1 and the second transformer primary Lp2, and the fourth node N4 is a node between the third transformer primary Lp3 and the second active switch S2. Because the voltages across the transformer primary windings Lp1 and Lp4 (Lp2 and Lp3) are cancelled each other, the clamping capacitor voltages, V_{C2} and V_{C3}, are equal to the input voltage. One driver signal is issued by the gate drive controller (not shown) to turn on/off the second active switch S2; while one complementary driver signal is also issued by the gate drive controller to turn on/off the first active switch S1. Consequently, an AC voltage is generated in the secondary winding Ls. After being rectified and filtered (not shown), the output of the single ended power converter provides an output voltage V0 to a load.

The single ended power converter operates as follows. Before the first time interval, both active switches S2 and S1 are turned off. During the first time interval, a gate drive signal is issued to turn on the active switch S2. In addition to the input voltage Vi applied to the primary windings Lp3-Lp4, the second and the third clamping capacitor voltages are also applied to its individual pair of primary winding Lp1-Lp3 and Lp4-Lp2, respectively. A magnetizing current associated with the transformer T1 increases linearly. At the end of the first time interval, the gate drive signal turns off the second active switch S2. The energies stored in the leakage inductance of the transformer T1 are absorbed by the clamping capacitors (C1, C2 and C3). Therefore, the voltage across the active switch S2 has no voltage spike and is limited to the sum of the three voltages provided by the voltage across the second clamping capacitor C2, the voltage across the third clamping capacitor C3, and the voltage across the first clamping capacitor C1.

The magnetizing and leakage energies are then recovered to the input via the second primary winding Lp2, the first clamping capacitor C1, the diode DS1, and the first primary windings Lp1, thereby resetting the transformer T1.

Due to the forward biased, DS1 is turned on. The transformer reset voltage is equal to the sum of the first clamping capacitor voltage V_{C1} and the second or the third clamping capacitor voltage (V_{C2} or V_{C3}). This operation condition is still valid because a complementary gate driver signal is applied to turn on the first active switch S1 before DS1 is turned off. Since the voltages across clamping capacitor, V_{C2} and V_{C3}, are clamped to input voltage Vi, the reset voltage can be thus higher than the input voltage. The duty cycle of the active switch S2, therefore, can be above 50%.

Obviously, a higher than 50% operating duty cycle results in increasing transformer turns ratio accompanied with a low primary current and lower voltage stresses on the secondary rectifiers. Consequently, further improvements of the single ended power converter's efficiency can be achieved.

As illustrated in FIG. 6B is another circuit diagram of the single ended power converter to introduce the concept of resetting a transformer via the clamping capacitors and to further reduce the current ripple as well as to alleviate the thermal stress of the transformer of the present invention. Two transformers, T1 and T2, are used to replace the transformer T1 in FIG. 6A. The transformer T1 has two identical primary windings Lp2 and Lp3 and has at least one secondary winding LS1; while the transformer T2 has two identical primary windings Lp1 and Lp4 and has at least one secondary winding LS2.

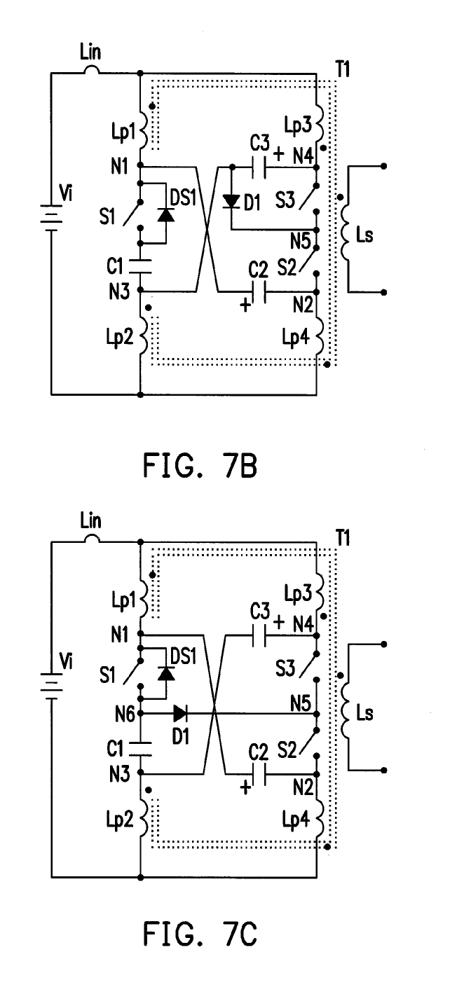

Another three embodiments of the single ended power converter constructed according to the foregoing principles of the present invention is shown in FIG. 7A, FIG. 7B and FIG. 7C. Two series-connected active switches S2 and S3 are used to replace the active switch S2 in FIG. 6A. A clamping diode D1 is used to clamp the second active switch S2 or the third active switch S3. As shown, the clamping diode D1 is connected between the fifth node N5 and the first node N1, or between the fifth node N5 and the third node N3, or between the fifth node N5 and the sixth node N6, respectively. Wherein the fifth node N5 is the center node of the third active switch S3 and the second active switch S2; while the sixth node N6 is a the center node of the first active switch S1 and the first clamping capacitor C1. The active switches, S2 and S3, are turned on simultaneously. To assure the voltage-clamping function performed by the diode D1, however, the turn-off timing of the gate drivers between the two active switches has to be designed properly. For example, the active switch S3 should not be turned off before the turning off of the active switch S2 in the circuit FIG. 7A. On the contrary, the active switch S2 should not be turned off before the turning off of the active switch S3 in the circuit FIG. 7B and FIG. 7C. As a result, the voltages across the active switch S2 and S3 can be thus clamped to Vi, or Vi+V_{C1}, respectively. Lower voltage rating active switch can be used for S2 and S3 and decrease the conduction loss.

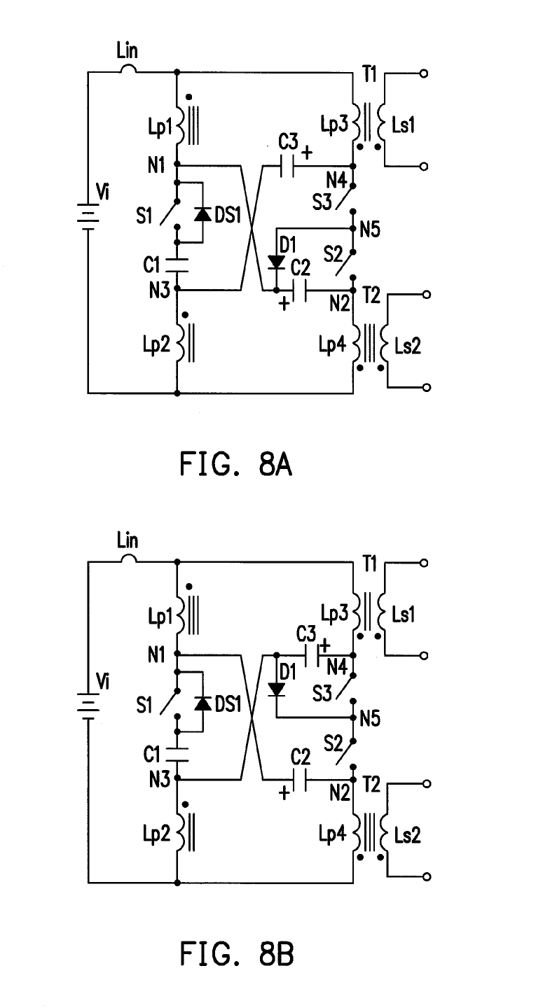

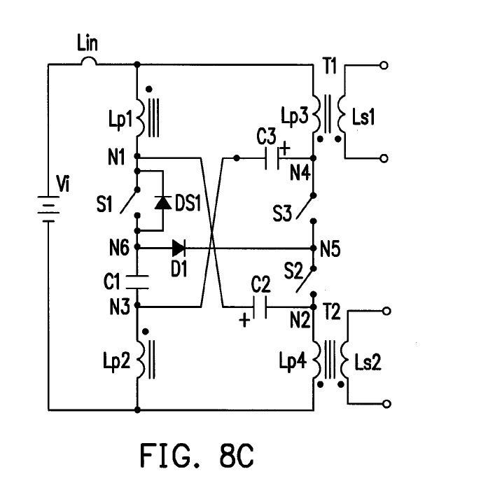

As illustrated in FIG. 8A, FIG. 8B, and FIG. 8C are another three circuit diagrams of the single ended power converter to introduce the concept of resetting a transformer via the clamping capacitors and to further reduce the current ripple as well as to alleviate the thermal stress of the transformer of the present invention. Two transformers, T1 and T2, are used to replace the transformer T1 in FIG. 7A, FIGS. 7B, and 7C, respectively. The transformer T1 has two identical primary windings Lp3 and Lp2 and has at least one secondary winding LS1; while the transformer T2 has two identical primary windings Lp1 and Lp4 and has at least one secondary winding LS2.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed:

1. A circuit to convert a DC voltage received at a DC input to an AC voltage, the circuit comprising:
a first series circuit connected in parallel with said DC input and comprising a first active switch paralleled with a first diode, a first clamping capacitor and a first transformer primary; wherein
said first diode is a body diode of the said first active switch or an external diode;
a second series circuit connected in parallel with said DC input and comprising a second transformer primary and a second active switch;
a second clamping capacitor connected between a first node within said first series circuit and a second node within said second series circuit, wherein said first node is between said first clamping capacitor and said first transformer primary, and wherein said second node is between said second transformer primary and said second active switch; and
at least one secondary of said transformer magnetically coupled to said first transformer primary and said second transformer primary and providing said AC voltage.

2. A circuit to convert a DC voltage received at a DC input to an AC voltage, the circuit comprising:
a first series circuit connected in parallel with said DC input and comprising a first active switch paralleled with a first diode, a first clamping capacitor and a first transformer primary; wherein
said first diode is a body diode of the said first active switch or an external diode;
a second series circuit connected in parallel with said DC input and comprising a second transformer primary, a third active switch, and a second active switch connected in series;
a second clamping capacitor connected between a first node within said first series circuit and a second node within said second series circuit, wherein said first node is between said first clamping capacitor and said first transformer primary, and wherein said second node is between said second transformer primary and said third active switch;
a second diode is connected between the DC input and the third node of the second series circuit or between the said first node within the first series circuit and the third node of the second series circuit wherein the third node is the center node of the said third active switch and the said second active switch; and
at least one secondary of said transformer magnetically coupled to said first transformer primary and said second transformer primary and providing said AC voltage.

3. A circuit to convert a DC voltage received at a DC input to an AC voltage, the circuit comprising:
an input inductor inserted between said DC input and a first series circuit as well as a second series circuit; wherein
said input inductor is a parasitic inductor or an external inductor;
said first series circuit connected in parallel with said second series circuit, said first series circuit comprises a first transformer primary, a first active switch paralleled with a first diode, a first clamping capacitor, and a second transformer primary; wherein
said first diode is a body diode of the said first active switch or an external diode; and
said second series circuit comprises a third transformer primary, a second active switch and a fourth transformer primary;
a second clamping capacitor is connected between a first node within said first series circuit and a second node within said second series circuit, wherein said first node is between said first transformer primary and said first active switch, and wherein said second node is between said second active switch, and said fourth transformer primary;
a third clamping capacitor is connected between a third node within said first series circuit and a fourth node within said second series circuit, wherein said third node is between said first clamping capacitor and said second transformer primary, and wherein said fourth node is between said third transformer primary and said second active switch;
at least one transformer has at least one secondary winding of said transformer is magnetically coupled to the said transformer primary windings and providing said AC voltage.

4. The circuit as claimed in claim 3, wherein said first transformer primary, said second transformer primary, said third transformer primary, and said fourth transformer primary are magnetically coupled to at least one transformer secondary winding of said transformer.

5. The circuit as claimed in claim 3, wherein said second transformer primary, said third transformer primary are magnetically coupled to at least one transformer secondary winding of a first transformer, wherein said first transformer primary, said fourth transformer primary are magnetically coupled to at least one transformer secondary winding of a second transformer.

6. A circuit to convert a DC voltage received at a DC input to an AC voltage, the circuit comprising:
an input inductor inserted between said DC input and a first series circuit as well as a second series circuit; wherein
said input inductor is a parasitic inductor or an external inductor;
said first series circuit connected in parallel with said second series circuit, said first series circuit comprises a first transformer primary, a first active switch paralleled with a first diode, a first clamping capacitor, and a second transformer primary; wherein said first diode is the body diode of the first active switch or an external diode; and
said second series circuit comprises a third transformer primary, a third active switch, a second active switch, and a fourth transformer primary;
a second clamping capacitor is connected between a first node within said first series circuit and a second node within said second series circuit, wherein said first node is between said first transformer primary and said first active switch, and wherein said second node is between said second active switch, and said fourth transformer primary;
a third clamping capacitor is connected between a third node within said first series circuit and a fourth node within said second series circuit, wherein said third node is between said first clamping capacitor and said second transformer primary, and wherein said fourth node is between said third transformer primary and said third active switch;
a second diode is connected between the fifth node and the said first node, or between the fifth node and the said third node, or between the fifth node and the sixth node, wherein the fifth node is the center node of said third active switch and said second active switch, and the sixth node is the center node of said first active switch and said first clamping capacitor; and
at least one transformer has at least one secondary winding is magnetically coupled to the said transformer primary windings and providing said AC voltage.

7. The circuit as claimed in claim 6, wherein said first transformer primary, said second transformer primary, said third transformer primary, said fourth transformer primary are magnetically coupled to at least one transformer secondary winding of said transformer.

8. The circuit as claimed in claim 6, wherein said second transformer primary, said third transformer primary are magnetically coupled to at least one transformer secondary winding of a first transformer, wherein said first transformer primary, said fourth transformer primary are magnetically coupled to at least one transformer secondary winding of a second transformer.
